(19) United States
(12) Patent Application Publication
(10) Pub. No.: US 2016/0000267 A1
(43) Pub. Date: Jan. 7, 2016

(54) Trigger-Enabled Kitchen Spoon

(71) Applicant: Evan KOTELES, (US)

(72) Inventor: Evan Koteles, Tampa, FL (US)

(21) Appl. No.: 14/766,946

(22) PCT Filed: Feb. 10, 2014
(86) PCT No.: PCT/US2014/015651

§ 371 Date: Aug. 10, 2015

Related U.S. Application Data
(60) Provisional application No. 61/762,921, filed on Feb. 10, 2013.

(51) Int. Cl. A47J 43/28

(52) U.S. Cl. CPC A47J 43/281

(57) ABSTRACT

An apparatus for transferring foods before, during or after being cooked is described. The apparatus is comprised of an elongated handle, with a cavity within the handle. The cavity of the elongated handle has lateral grooves that run longitudinally along lateral sides, with an opening running longitudinally along a top surface of the elongated handle. Coupled to the elongated handle is a bowl. The bowl has an opening at the bottom of the bowl, a turret, and a releasably sealable cover. The opening in the bottom of the bowl opens into the turret. The turret has a circumferential slot and the circumferential slot of the turret is operably coupled to the releasably sealable cover, forming a releasable seal between the circumferential slot of the turret and the opening of the bowl.

### FIELD OF THE INVENTION

The present invention relates generally to kitchen utensils. More specifically, the present invention relates to spoon or ladle for transferring material safely and securely.

### BACKGROUND OF INVENTION

There is a need for devices able to accurately measure and transfer ingredients during cooking, baking and other activities. The ingredients may be liquid, liquid-solid or granule. This ability will help reduce spills and waste.

The traditional kitchen ladle is used for transferring various liquid and liquid-solid content from one container to another such as soup, stew, punch, sugar and the like. A traditional ladle is designed with a bowl-like cup connected to a handle extending up and away from the cup at various angles.

To use a traditional ladle, the user grips the handle and submerges the bowl-like cup into whatever content said user wishes to transfer.

To dispense the content into the destination container, said user hovers the ladle a few inches over the destination container. The user then turns their wrist to dump the content over the edge of the ladle and into the new container.

The design of a traditional ladle has been used for many years. However, there are flaws in the traditional design. The major drawback of the traditional ladle is the lack of accuracy when pouring content from the ladle to another container. Transferring liquid, or a liquid-solid mixture, from one container to another currently requires the awkward motion of twisting the wrist. The likelihood of spilling is great due to the lack of control and accuracy over the content flowing over the edge of the cup. When transferring a liquid-solid mixture, the content is even more likely to spill and run off the back of the cup of the ladle.

Furthermore, the function of a ladle is frequently used to transfer left-over foods into jars or bottles for storage. These jars and bottles are equipped with small openings for the content to be poured into. The traditional ladle is not suited to make such accurate pours and, as a result, much of the content being transferred may be spilled or wasted.

Accordingly, there exists a need for an improved ladle for more accurate and easy transfer of content to another container, especially if the destination container has a smaller than desired opening to pour into.

### SUMMARY OF INVENTION

A first aspect of the present invention provides an apparatus for transferring foods before, during or after being cooked. The apparatus is comprised of an elongated handle, with a cavity within the handle. The cavity of the elongated handle has lateral grooves that run longitudinally along lateral sides, with an opening running longitudinally along a top surface of the elongated handle. Coupled to the elongated handle is a bowl. The bowl has an opening at the bottom of the bowl which opens into a turret, and a releasably sealable cover. The turret has a circumferential slot. A releasable seal between the circumferential slot of the turret and the opening of the bowl forms when the releasably sealable cover is inserted into the circumferential slot.

A second aspect of the present invention provides a slidable trigger for opening or closing an opening at a bottom of a bowl or ladle. The trigger is has an elongated shaft. The shaft has a top surface, where the top surface of the trigger is accessible for a user to slide the trigger along the longitudinal axis of the elongate handle by engaging the top surface of the trigger with his finger tip via an opening in the top surface of the elongated handle. The shaft also has laterally depending extensions from lateral sides of the elongated shaft that run longitudinally along longitudinal grooves in lateral sides of the elongated handle. A proximal end of the elongated shaft is operably coupled to a releasably sealable cover of an opening in a bottom of a bowl of the ladle.

### BRIEF DESCRIPTION OF THE FIGURES

The features of the invention are set forth in the appended claims. The invention itself, however, will be best understood by reference to the following detailed description of an illustrative embodiment when read in conjunction with the accompanying drawings, wherein:

FIG. 1A depicts a side elevation view of a hand-held device 50, e.g. a trigger-enabled ladle or spoon, in accordance with embodiments of the present invention;

FIG. 1B depicts a side elevation view of the hand-held device 50, e.g. a trigger-enabled ladle or spoon, depicted in FIG. 1A, after assembly, in accordance with embodiments of the present invention;

FIG. 2 depicts a front elevation view of hand-held device 50, e.g. a trigger-enabled ladle or spoon, in accordance with embodiments of the present invention; and

FIG. 3 depicts a rear elevation view of the bowl of the hand-held device 50, e.g. a trigger-enabled ladle or spoon in accordance with embodiments of the present invention; and

FIG. 4 depicts a front elevation view of the hand-held device 50, e.g. a trigger-enabled ladle or spoon, in accordance with embodiments of the present invention; and

FIG. 5 depicts a side elevation view of the hand-held device 50, e.g. a trigger-enabled ladle or spoon, in accordance with embodiments of the present invention;

FIG. 6-7 depict a spring in a compressed or expanded state in a side elevation view of the hand-held device 50, e.g. a trigger-enabled ladle or spoon, in accordance with embodiments of the present invention; and

FIG. 8 depicts a flow diagram for a method 100 for releasably sealing an opening at a bottom of a bowl, in accordance with embodiments of the present invention.

### DETAILED DESCRIPTION OF THE EMBODIMENTS OF THE INVENTION

Definitions:

Hereinafter, unless otherwise defined, the term “proximal end” refers to the end of an extension from the cup or bowl 1, 12 of the hand-held device 10, 50 that is closest to the cup or bowl 1, 12. In contrast, the term “distal end” refers to the end of an extension from the cup or bowl 1, 12 of the hand-held device 10, 50 that is farthest from the cup or bowl 1, 12.

Hereinafter, unless otherwise defined, the term “operably coupled” means connecting two or more objects so that they function as being mechanically and physically connected.

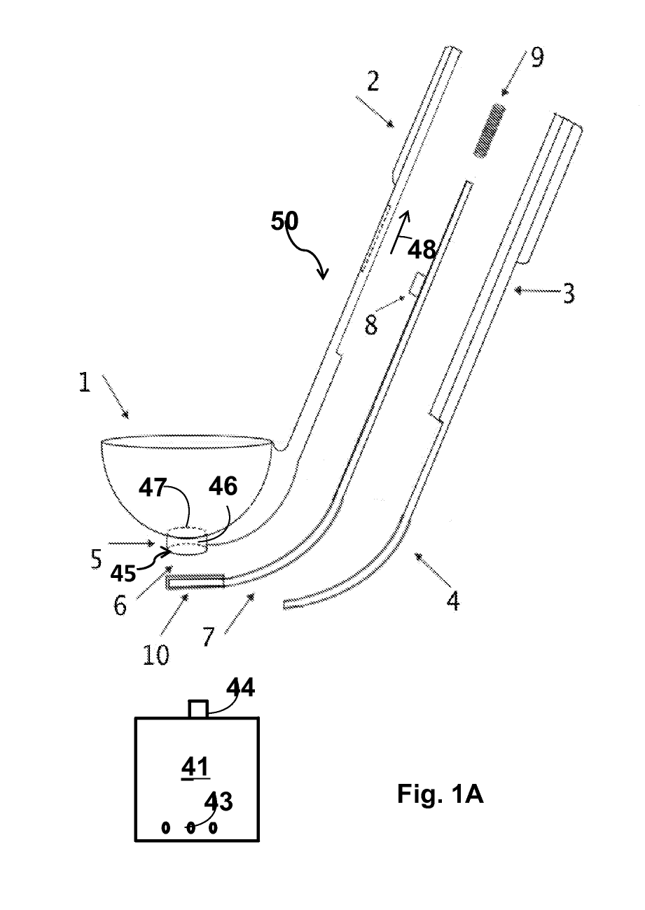

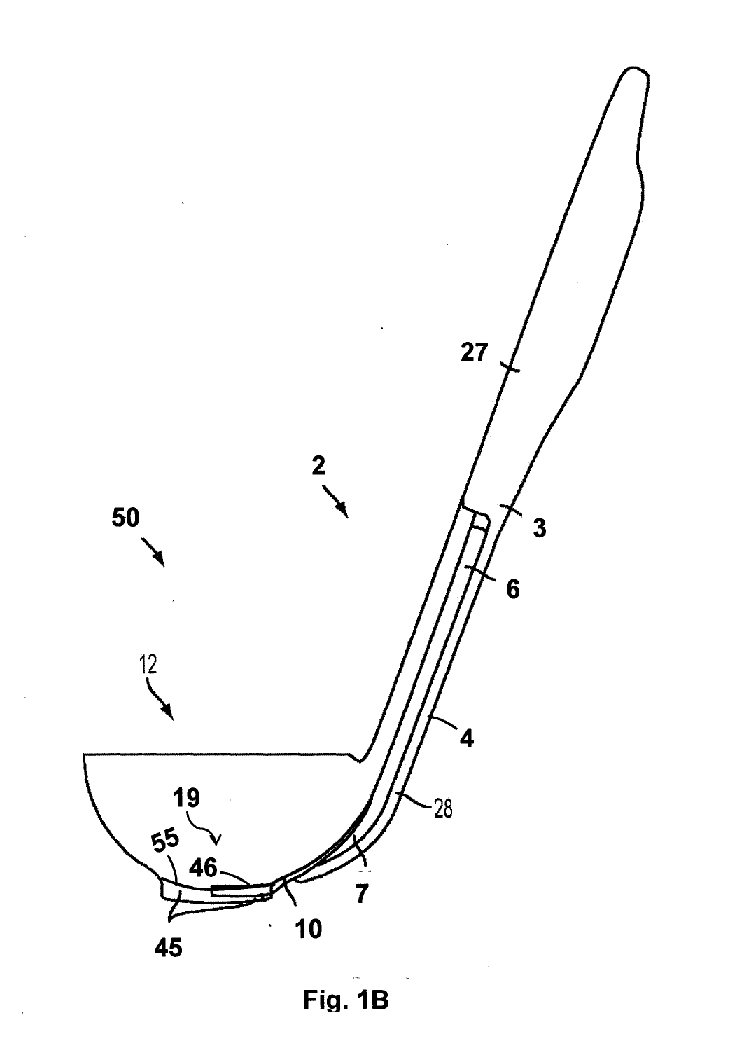

FIG. 1A depicts a side elevation view of a hand-held device 50, e.g. a trigger-enabled ladle or spoon, that may transfer liquid, liquid-solid or granule content 43, such as food, from the hand-held device 50 to another container 41 accurately and easily. The practical design and placement of the components make it easy to use. The present invention will no longer require the uncomfortable twisting of the wrist and will provide a much more accurate pour to transfer content 43 into containers 41 with small openings 44.

In one embodiment the ladle or spoon 50 may be a deep bowl-like ladle comprising a turret 45 extending from a hole 5 in a bottom of a cup 1. The turret 45 comprises a circumferential slot 46 in turret wall 47. This hole 5 may be releasably sealed by door 7 that is insertable into circumferential slot 46 and operably coupled at a base of an elongated shaft 6 that extends along a length of a handle 2 of the ladle or spoon 50. Attached to a distal end of this elongated shaft 6 is a trigger 8 that may be accessible to the thumb of a user.

The user may slide the trigger 8 back in a direction of the arrow 48 and as a result will withdraw the releasably sealable door 7 from the circumferential slot 46, thus exposing the hole 5 on the bottom of the cup 1. This allows the content 43 to very accurately fall into its new container 41, even though it may fall through a small opening 44. A spring 9 exists in a cavity of the handle 2 of the ladle or spoon 50. When the trigger 8 is pulled back or moved in the direction of the arrow 48, the spring 9 compresses. When released, the spring 9 expands and pushes the elongated shaft 6, and releasably sealable door 7, back down to seal the hole 5 at the bottom of the cup 1.

In one embodiment, the releasably sealable door 7 may be coated with a rubber seal 10.

Material of the present invention can include any combination of plastic, metal, silicone and rubber. Ideally, a commercially used version would be primarily composed of metal and a residentially used version would be composed of plastic, silicon and rubber.

A large, deep cup (1) is the structural component of the invention. The handle 2 with a cavity, an opening on the top, and open-back with tracks that extends up and away from the spoon 50 is also a structural component that allows the other components to be attached or function successfully. A hole 5 at the bottom of the ladle or spoon 50 provides for the main function of the invention. A releasably sealable door 7 rests inside the cavity of the handle 2 and is secured into the handle 2 by the back piece of the handle 3. This releasably sealable door 7 is used to open and close the hole 5 at the bottom of the ladle or spoon 50 by means of the trigger 8 that is connected to the elongated shaft 6. The trigger 8 extends out of an opening on the top of the handle 2 so that the user can access it when holding the handle 2. The track 4 extending from the back piece of the handle 3 directs the releasably sealable door 7 to insert into the circumferential slot 46 in the turret 45 underneath the bottom of the hole 5 in the cup 1. A rubber seal 10 attached to the releasably sealable door 7 helps seal the hole 5 at the bottom of the cup 1. A compression spring 9 within the cavity of the handle 2 compresses when the user opens the releasably sealable door 7 by moving the trigger 8 in the direction of the arrow 48 and reverts to the original extended position when the user releases the trigger 8, re-inserting the releasably sealable door 7 into the circumferential slot 46 in the turret 45 underneath the bottom of the hole 5 in the cup 1.

FIG. 1B depicts a side elevation view of the spoon or ladle 50 depicted in FIG. 1A, after the back piece of the handle 3, the elongated shaft 6, and the handle 2 have been assembled. The handle 2 comprises a distal surface 27 and a proximal surface 28.

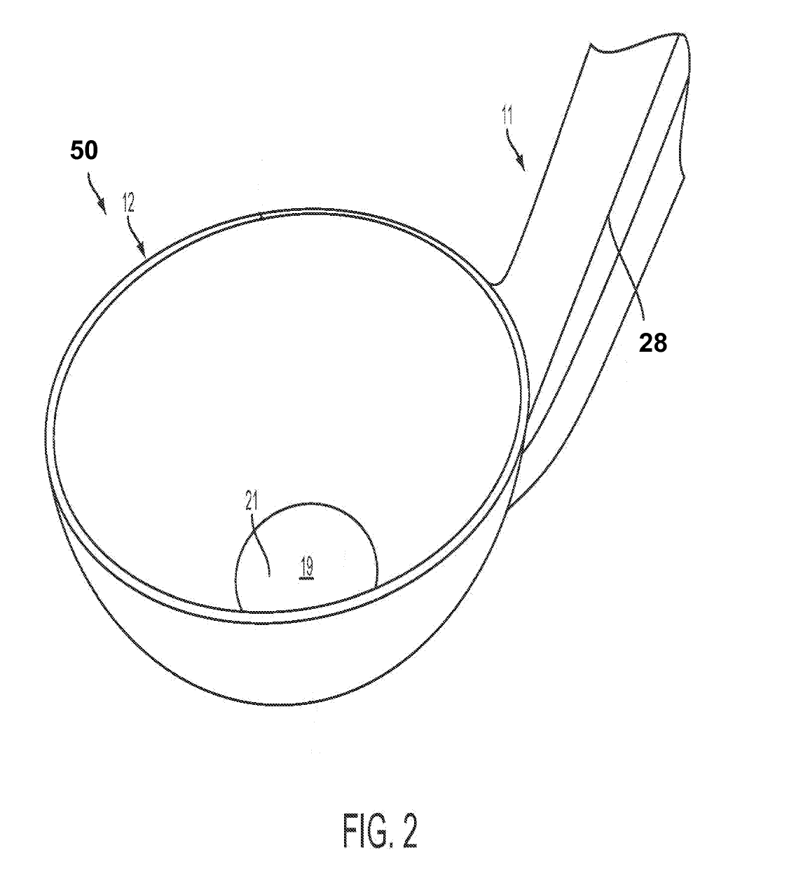

FIG. 2 depicts a front elevation view of the hand-held device 50, e.g. a trigger-enabled ladle or spoon. The bowl 12 has an opening 19 at the bottom of the bowl, a circumferential slot 46 in turret 45, and a d releasably sealable door 7.

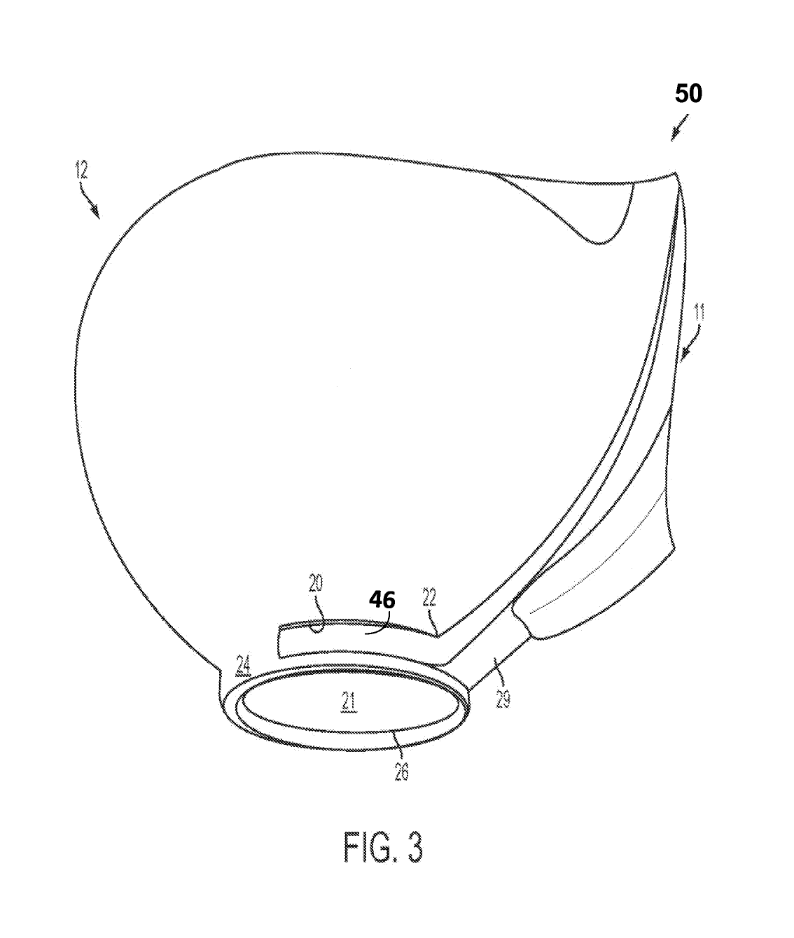

FIG. 3 depicts a rear elevation view of the hand-held device 50, e.g. a trigger-enabled ladle or spoon. The opening 19 in the bottom of the bowl opens into the circumferential turret 45, and the circumferential turret 45 is operably coupled to the releasably sealable cover 21, forming a releasable seal 20 between the circumferential turret 45 and the opening 19 of the bowl.

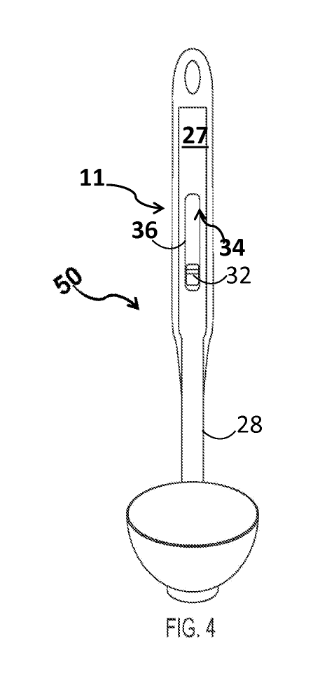

FIG. 4 depicts a front elevation view of the hand-held device 50, e.g. a trigger-enabled ladle or spoon. In an embodiment, there is a slidable trigger 32 for opening or closing the opening 19 at the bottom of the bowl 12. The trigger 32 is operably coupled to an elongated shaft 6. The shaft 6 is comprised of a top surface 27, where the top surface 40 of the trigger 32 is accessible for a user to slide the trigger 32 along the longitudinal axis of the handle 11 by engaging the top surface 40 of the trigger 32 with his finger tip via an opening 36 in the top surface of the elongated shaft 6. The shaft 6 also has laterally depending extensions 37 from lateral sides 38 of the elongated shaft 6 that run longitudinally along longitudinal grooves 41 in lateral sides 52 of the handle 11. An operable coupling 22 may operably couple a proximal end 29 of the elongated shaft 6 to the releasably sealable cover 21.

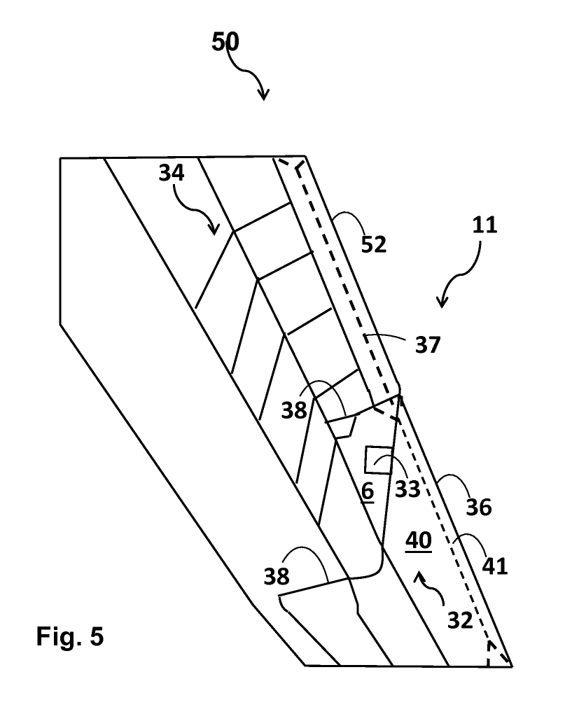

FIG. 5 depicts a side elevation view of the hand-held device 50, e.g. a trigger-enabled ladle or spoon, comprising a cavity 34, beneath the distal surface 27 of the elongated handle 2. The cavity 34 contains the elongated shaft 6 which operably couples slidable trigger 32 to trigger shaft 33. Slidable trigger 32 may slide along lateral grooves 41 that run longitudinally along lateral sides 52 of the handle 11. with an opening 26 running longitudinally along a top surface 27 of the elongated handle. Coupled to the elongated handle is a bowl 12.

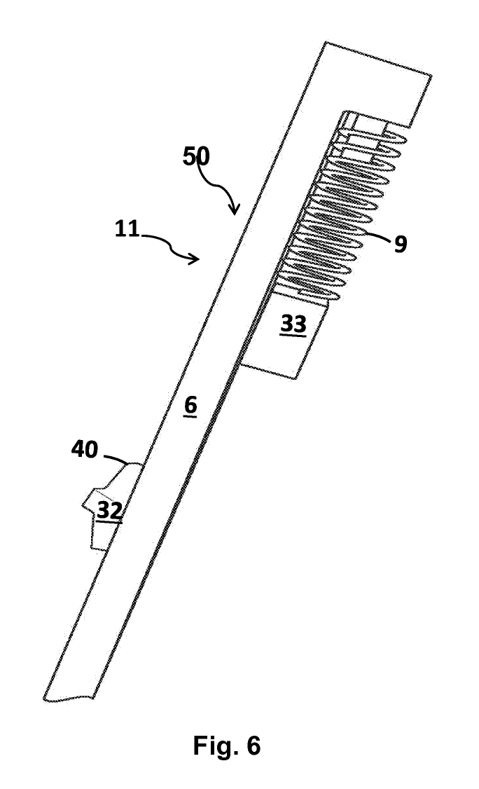

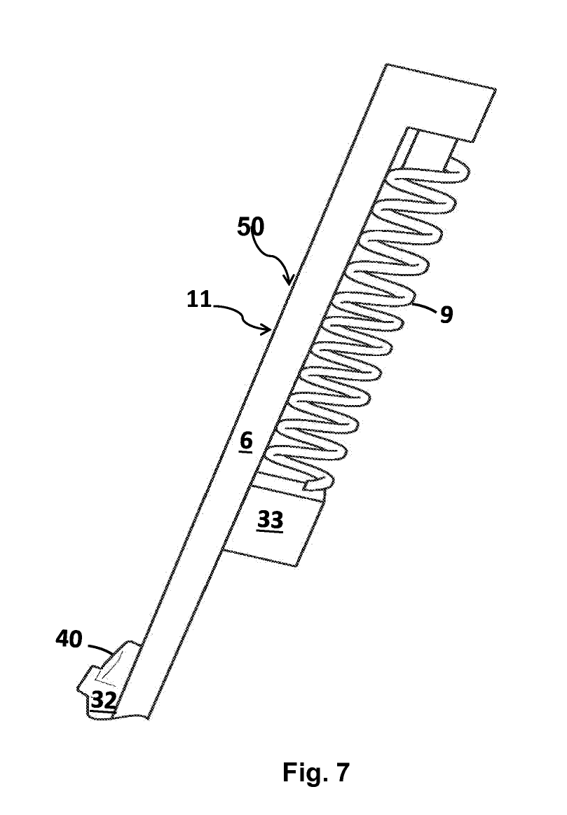

FIGS. 6-7 depict a spring 9 in a compressed or expanded state, in a side elevation view of the hand-held device 50, e.g. a trigger-enabled ladle or spoon. A trigger 32 that may be accessible to the thumb of a user is operably coupled to the elongated shaft 6.

The user may slide the trigger 32 back in a direction of the arrow 48, depicted in FIG. 1A, and described in associated text, herein, and as a result will withdraw the releasably sealable door 7 from the circumferential slot 46, thus exposing the hole 5 on the bottom of the cup 1. This allows the content 43 to very accurately fall into its new container 41, even though it may fall through a small opening 44. The spring 9 exists in a cavity of the handle 2 of the hand held device 50, e.g., a trigger-enabled ladle or spoon. When the trigger 8 is pulled back or moved in the direction of the arrow 48, the spring 9 compresses, as shown in FIG. 6. When released, as shown in FIG. 7, the spring 9 expands and pushes the elongated shaft 6, and releasably sealable door 7, back down to seal the hole 5 at the bottom of the cup 1.

In an embodiment, the top surface 27 of the slidable trigger 32 has a rough texture.

In an embodiment, the bowl 12 is made from a material selected from the group consisting of plastic, metal, silicone and rubber. In an embodiment, the metal is stainless steel.

In an embodiment, the releasably sealable cover 21 is made of a compressible material. The compressible material can be selected from the group consisting of plastic, rubber, and silicone.

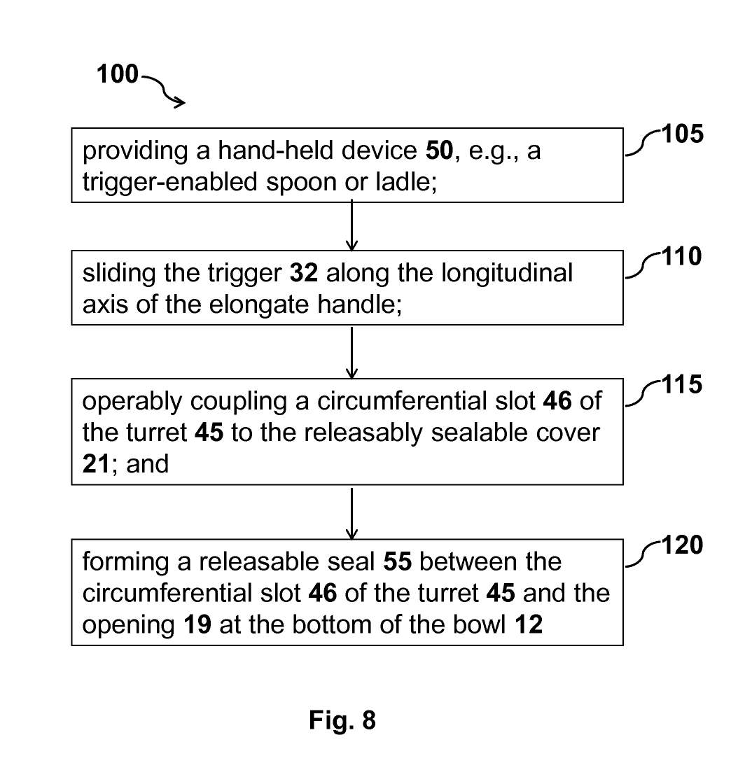

FIG. 8 depicts a flow diagram for a method 100 for releasably sealing an opening 19 at a bottom of a bowl 12 of a hand-held device 50, e.g., a trigger-enabled spoon or ladle. The method 100 comprises a step 105 in which a hand-held device 50, e.g., a trigger-enabled spoon or ladle is provided. In a step 110, a user slides a trigger 32 releasably sealing the opening 19 at the bottom of the bowl 12 by sliding the trigger 32 along the longitudinal axis of the elongate handle by engaging the top surface 40 of the trigger 32 with his finger tip via an opening 36 in the top surface 27 of the elongated handle 11. In a step 115, a circumferential slot 46 of the turret 45 is operably coupled to the releasably sealable cover 21. In a step 120, a releasable seal 55 is formed between the circumferential slot 46 of the turret 45 and the opening 19 at the bottom of the bowl 12.

A slidable trigger 32 for opening or closing an opening at a bottom of a bowl of a ladle has an elongated shaft 6. The elongated shaft 6 is comprised of a top surface 27 and a proximal end 29. The top surface 40 of the trigger 32 is accessible for a user to slide the trigger 32 along the longitudinal axis of the elongate handle 11 by engaging the top surface 40 of the trigger with his finger tip via an opening 36 in the top surface 27 of the elongated handle 11. The elongated shaft 6 also has laterally depending extensions 37 from lateral sides of the elongated shaft 6 that run longitudinally along longitudinal grooves 41 in lateral sides of the elongated handle. A proximal end 39 of the elongated shaft is operably coupled 22 to the releasably sealable cover 21 of an opening 19 in a bottom of a bowl 12 of the ladle.

In an embodiment, the top surface 27 of the slidable trigger 32 has a rough texture.

In an embodiment, the bowl 12 is made from a material selected from the group consisting of plastic, metal, silicone and rubber. In an embodiment, the metal is stainless steel.

In an embodiment, the releasably sealable cover 21 is made of a compressible material. The compressible material can be selected from the group consisting of plastic, rubber, and silicone.

While exemplary embodiments have been specifically disclosed, it should be understood that the practice of this invention is not limited to those embodiments. Modifications and variations falling within the spirit of the invention will occur to those skilled in the art. Therefore, it is not intended that the scope of the invention be determined by the disclosed exemplary embodiments, but rather should be determined by the breadth of the appended claims.

1. An apparatus for transferring foods, before, during or after being cooked, comprising:
an elongated handle, comprising:
a cavity within the handle,
wherein the cavity of the elongated handle has lateral grooves that run longitudinally along lateral sides, and an opening running longitudinally along a top surface of the elongated handle; and
a bowl,
wherein the elongated handle and the bowl are operably coupled;
the bowl comprising:
an opening at a bottom of the bowl;
a turret having a circumferential slot; and
a releasably sealable cover;
wherein the elongated handle and the bowl are operably coupled,
wherein the opening in the bottom of the bowl opens into the turret, and
wherein the turret is operably coupled to the releasably sealable cover, forming a releasable seal between the circumferential slot of the turret and the opening at the bottom of the bowl.

2. The apparatus of claim 1, comprising:
a slidable trigger for opening or closing the opening at the bottom of the bowl, comprising:
an elongated shaft, comprising:
a top surface,
wherein the top surface of the trigger is accessible for a user to slide the trigger along the longitudinal axis of the elongate handle by engaging the top surface of the trigger with his finger tip via an opening in the top surface of the elongated shaft, and
laterally depending extensions from lateral sides of the elongated shaft that run longitudinally along longitudinal grooves in lateral sides of the elongated handle,
wherein a proximal end of the elongated shaft is operably coupled to the releasably sealable cover.

3. The apparatus of claim 2, wherein the top surface of the slidable trigger has a rough texture.

4. The apparatus of claim 1, wherein the bowl is made from a material selected from the group consisting of plastic, metal, silicone and rubber.

5. The apparatus of claim 4, wherein the metal is stainless steel.

6. The apparatus of claim 1, wherein the releasably sealable cover is made of a compressible material.

7. The apparatus of claim 6, wherein the compressible material is selected from the group consisting of plastic, rubber, and silicone.

8. A method for releasably sealing an opening at a bottom of a bowl of a ladle, comprising:
providing the apparatus of any preceding claim;
a user releasably sealing the opening at the bottom of the bowl by sliding the trigger along the longitudinal axis of the elongate handle by engaging the top surface of the trigger with his finger tip via an opening in the top surface of the elongated handle, so that the turret is operably coupled to the releasably sealable cover;
forming a releasable seal between the turret and the opening at the bottom of the bowl.

9. A slidable trigger for opening or closing an opening at a bottom of a bowl of a ladle, comprising:
an elongated shaft, comprising:
a top surface,
wherein the top surface of the trigger is accessible for a user to slide the trigger along the longitudinal axis of the elongate handle by engaging the top surface of the trigger with his finger tip via an opening in the top surface of the elongated handle, and
laterally depending extensions from lateral sides of the elongated shaft that run longitudinally along longitudinal grooves in lateral sides of the elongated handle,
wherein a proximal end of the elongated shaft is operably coupled to a releasably sealable cover of an opening in a bottom of a bowl of the ladle.

10. The apparatus of claim 9, wherein the top surface of the slidable trigger has a rough texture.

11. The apparatus of claim 9, wherein the bowl is made from a material selected from the group consisting of plastic, metal, silicone and rubber.

12. The apparatus of claims 9, wherein the metal is stainless steel.

13. The apparatus of claims 9, wherein the releasably sealable cover is made of a compressible material.

14. The apparatus of claim 13, wherein the compressible material is selected from the group consisting of plastic, rubber, and silicone
